(19) United States
(12) Patent Application Publication
(10) Pub. No.: US 2009/0218986 A1
(43) Pub. Date: Sep. 3, 2009

(54) Method and Apparatus for the Management of Battery Cells

(75) Inventor: Jukka Jarvinen, Hikia (FI)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Oy Finnish Electric Vehicle Technologies Ltd., Riihimaki (FI)

(21) Appl. No.: 12/299,434

(22) PCT Filed: May 7, 2007
(86) PCT No.: PCT/FI2007/050250

§ 371 Date: May 14, 2009

(30) Foreign Application Priority Data
May 5, 2006 (FI) 20065294

(51) Int. Cl. H02J 7/00

(52) U.S. Cl. 320/119; 320/124; 320/116

(57) ABSTRACT

A method and apparatus for the management of rechargeable series-connected cells (C1, C2, C3) by means of individual measurements, by monitoring each cell during the course of its charging, storage or discharging cycle for measuring the cell properties and for adjusting the properties of inconsistent cells by manipulating the same for mitigating inter-cellular discrepancies.

The invention relates to monitoring the condition of more than one series-connected battery cells and managing a battery during the course of charging, storage and discharging cycles.

The capacity of series-connected cells is always determined by the weakest one. Typically, the voltages and temperatures of cells are measured during charging and discharging. Charging is stopped when measurement indicates that one of the cells is full and discharging is stopped when the first cell is empty. If this function fails, for example in the process of discharging a battery, one of the cells will be exhausted before the others and it is over discharged. Most types of batteries sustain serious damage if the poles reverse polarities even momentarily or certain limit values are repetitively exceeded. This is why large batteries, i.e. accumulator batteries consisting of several cells, are generally monitored in a cell-specific manner.

The solutions in prior art, like U.S. Pat. No. 6,373,226 B1 (ITOU ET AL.), and EP 0 814 556 A2 (FORD GLOBAL TECHNOLOGIES), the methods and hardware are based on pre-set parameters and predicted operating models. Additionally, the later patent describes pretty clearly the methods used for controlling lead acid batteries, and therefore they can not work with Lithium batteries. In both applications the means are taken only after the symptoms are detectable. The methods of these publications are not aiming to condition the properties of battery cells to be alike to each other, but the methods are based on correction the symptoms of unbalance and correcting the unbalance by discharging or charging the individual cells according the estimated state of charge.

It has been also proven facts in the behaviour of the lithium battery that it could be claimed that U.S. Pat. No. 6,373,226 B1 deteriorates the in practice the life time and security of serially connected sells compared to the solution according the invention. We have testified a number of fires of portable computer batteries around the world, specifically because of the poor battery management.

In practice according the invention the cells are protected by proactive measures and methods in which case even in case of serial connection of hundreds cells a long lifetime is reached safely and economically. The state of art solution U.S. Pat. No. 6,373,226 B1 (ITOU ET AL.), it is not possible to achieve a noteworthy lifetime even with over 10 serially connected cells. The device is clearly designed for light consumer electronics solution. By reacting only to low state of charge of a cell or group of sells and charging the sells individually to full charge, properties of cells are not getting similar, which would enable load tolerance and fast charging of cells in vehicle use.

It is an objective of the invention to provide a method and apparatus, enabling a service life as long as possible for series-connected cells and minimizing the risk of battery damage. In vehicle use important property, rapid charge is also something that requires consistent properties of a battery for supplying the same with a capacity as high as possible over a period as short as possible. According to the invention, the management of cells is effected individually. Instead of just monitoring that none of the cells is damaged or excessively stressed, this involves a more comprehensive evaluation of battery condition and manipulation of properties. If the stress is equal on all cells, the weakest one will become defective much sooner than the others. According to the invention, all cells are stressed in proportion to the properties thereof for providing the cells with properties more equal to each other. This method is used to condition properties of the cells for a considerably simpler control and operation of the whole assembly. After couple of hundred charge-discharge cycles the battery cells are considerably more equal to each other. Since the cells are quite identical, even an empty battery can be subjected to vigorous loading without power compensation.

The proportioning of stress is effected by using experimentally tested learning algorithms capable of making use of statistical data collected from the cells. When a battery pack is designed this way, the properties of various cells approach each other when progressing further in the cyclic service life of the battery. Traditional control and supervision of cells has been practiced by not loading the weakest battery excessively. Some systems by-pass the weakest cell in the process of discharging, but usually the power of an entire battery is just limited to comply with the weakest cell. As for charging, the common practice is to merely stop the charging process when the first cell is full, at most the charging of a cell with the lowest leakage current is stopped before the others, thus hoping for a more or less full charge in each cell. A downside in this type of prior art battery management is that, in the process of such discharge, the weakest battery is always under most stress and becomes even weaker in practice. In the event that the weakest cell sustains damage, it is almost certain that its replacement is so different from the others in terms of its properties that the battery is no longer capable of working as intended. Even if the new cell would work successfully, it would be a burden because of its better efficiency. Thus, the differences in the efficiency would take it out of balance in relatively short time. Replacing a single damaged cell is not economical. The next cell should be replaced shortly because of the same failure mechanism. It is a notable feature, particularly in lithium batteries, that a very short cycle does not provide a longer cyclic service life logarithmically. Also the position in the capacity window is relevant. A new clearly more powerful cell also deteriorates quickly in terms of its properties as a result of deficient cyclicity, but the deterioration is different from the other already older cells. Therefore, a constant compensation will be needed with high probability during the whole service life of the battery. That will possible prevent the efficient use of the battery as whole.

The method of the invention comprises tracking cells as individuals and manipulating the same for bringing properties of the cells permanently closer to each other. The main criterion is the individual capacities of cells. In most of the advanced systems existing today, cells are indeed tracked as individuals but instead, for example upon discovering that one cell has a capacity higher than the others, said cell is not for example subjected to a deep discharge or a slight overcharge compared to other cells, but in practice the charging and discharging cycle of a cell with a capacity higher than the others is in fact lower with respect to its own intrinsic capacity than that in the other cells. Thus, a cell better than the others is stressed proportionally less than the other cells, and the inter-cellular differences increasing even further in the case of most battery types. The properties of a battery change intensely, leading to a situation with no control over the operation of an entire battery. The changing quantities may include for example impedance and capacity. These quantities change incoherently in all upcoming cycles. Prior art methods have a capability of compensating for symptoms, but cannot correct the actual defect.

The system of the invention discovers that one of the cells has a capacity higher than others during a charging or discharging process. Instead of just stopping the charging process as the weakest cell becomes fully charged, the most powerful cell is for example charged slightly more than the others. The result is that the most powerful cell sustains slight damage and its capacity decreases closer to other cells. The discharging process is indeed stopped whenever the voltage of even a single cell decreases too much, which means that in practice the discharge must always be stopped as determined by the cell of the lowest state of charge. However, this feature is counteracted by anticipation, wherein the weakest cell is supplied with some “virtual capacity” from all slightly more powerful cells, causing the weaker cell to discharge more slowly than the other cells. For example the charging can be made with 1% of the discharging current, resulting to 99% discharge cycle compared to other cells. The charging during the discharge cycle is lowering the stress of the cell and not actually charging the cell. The anticipation data is acquired by computing from meticulously collected statistical data. Then, also in the subsequent discharge cycle, the weakest cell can be treated a bit more gently than the other cells, i.e. it is possible, for example, to transfer energy for assisting the weakest cell during the next discharge cycle by using a single cell's galvanically isolated charger operating on the voltage of an entire battery. The weakest cell is saved also during the charge, that is, it is charged bit less compared to its internal capacity. This can be cone by for example charging with the other cells with 1% higher current or by bypassing part of the charging current by resistor or by CS-circuit (CS=switched capacitor).

Thus, in the next charge and discharge cycle, the weakest cell is stressed slightly less than the others and the discrepancy evens out. In the prior art practice, the weakest cell is stressed in every cycle more than the others with respect to its capacity and thereby deteriorates even more. The method according the invention is easing the weaker cell both during charge and discharge. At its best the prior art systems charge the cell in lower charge level in the end of the charge cycle. However, this makes the next charge cycle more stressful than that of other cells. The prior art systems are therefore generally reacting to cells behaviour on the grounds of momentary measurement information. The system according to the invention works on the ground of collected history information and plans in advance the needed compensating measures. The prior art doesn't take in account the capacity differences of cells when managing the depth of charge discharge cycle controlling charging and discharging on the bases of cell voltage differences.

In order to function as intended, the system keeps record of the charge, discharge, temperatures, behaviour, as well as other necessary aspects of each cell. For example, when a given cell has been intentionally overcharged, it can be expected to still have more charge than the others at the end of a subsequent discharge cycle. However, the difference in capacity is detectable over the very next cycle in the cell behaviour. This must be taken into account. This particular cell can be discharged as required by the cell condition along with other cells for all of those to attain empty and full charge levels at the same time. Since, according to the invention, some of the capacity of a single cell is intentionally discarded, it is advisable to keep algorithms quite moderate, i.e. to equalize properties of the cells little by little. The ultimate changes, which have an impact on the operation of a battery, will be equalized at a very early stage of its life cycle. However, the operation and conditioning processes of cells will be continued for as long as the system is in service.

Another essential aspect in terms of tracking cells is that the temperature of batteries has a considerable effect on the behaviour thereof. Therefore, it is necessary to monitor and keep record of each cell's temperature.

In order to learn more about the behaviour of cells, the system has a logical and controlling module which comprises a general-purpose central processing unit, for example a computer. This central processing unit oversees the battery and holds necessary information for controlling functions of the entire system. The system's central processing unit can also be used, for example, for navigation and for controlling other functions of a desired application. The central processing unit may use its own data transfer link or the system can be provided with a separate terminal unit, for example a mobile phone, for communication. This provides a convenient way of updating management algorithms for cells and enables collecting a considerable amount of experimental information about the behaviour of the entire system for on-line servers.

The centralized server may further work as means for authentication for remote units, when the operation history can be certified for example to ensure the use based billing so that the user can not modify the software of the collected operation history. At same time the copyright of the software is certified, because the serial number and history of each batter is logged to the server, and copied usage information of copied serial number would come out. Smart card based protection can be used to protect the software and algorithm. In that case part of the programme can be sent encrypted and it is stored in the read protected memory in a way that copying and modifying it is very difficult. That makes possible to update the devices belonging to a large system in a way that the details of battery management algorithms can be kept business secret and also the measurement data can be collected without revealing it to outsiders. Further the billing of for example rental batteries can be based on real usage information that can be collected for billing in a data secure manner.

The collected information can be utilized by a manufacturer for example in neural networks or as material for an analysis conducted by statistical methods for developing a more effective future system. This telecommunication can also be used for varying algorithms in various units. Hence, a research environment is established, which covers all units that have been sold and which brings forth a more functional system to the benefit of a customer. For example, a customer is able to acquire examined information regarding the effect of his/her driving routines on duration of the battery and on a probable remaining service life of the system. It is also possible to determine what the service life would be if, for example, the cells could be charged more frequently or if driving speeds could be brought down a bit.

The system's central processing unit includes advantageously a user interface and an operating system. The user interface can be for example graphical. The information associated with cells is confidential and included in a strongly encrypted database, making the driving history of an automobile impossible to read without a cryptographic key. The database information enables reading for example driving speeds, power trends, charging times, trips driven in distances and graphs, temperatures of a vehicle, cells and ambience. Thus, it should be stressed that the information must not violate the driver's protection of privacy. The user undertakes to abide by the operating system licensing clauses, which secure a sufficiently extensive protection for the user as well as a sufficiently extensive amount of information for an optimal operation of the system. Another reason for encrypting the information is to ensure the reliability of information in warranty matters, for example the aggregate number of charging processes and the applied powers may constitute an object of warranty clauses and thus must not be easily modifiable. Neither is the information allowed to reveal for example geographic coordinates, which could enable localizing the system with criminal intent. Geographic coordinates, with the exception of elevation, are not relevant for battery management.

A method, an apparatus and a program code tool of the invention are characterized by what is claimed in independent claims 1, 6 and 7, respectively. The dependent claims present preferred embodiments of the invention.

A system of the invention will now be described with the aid of a FIGURE.

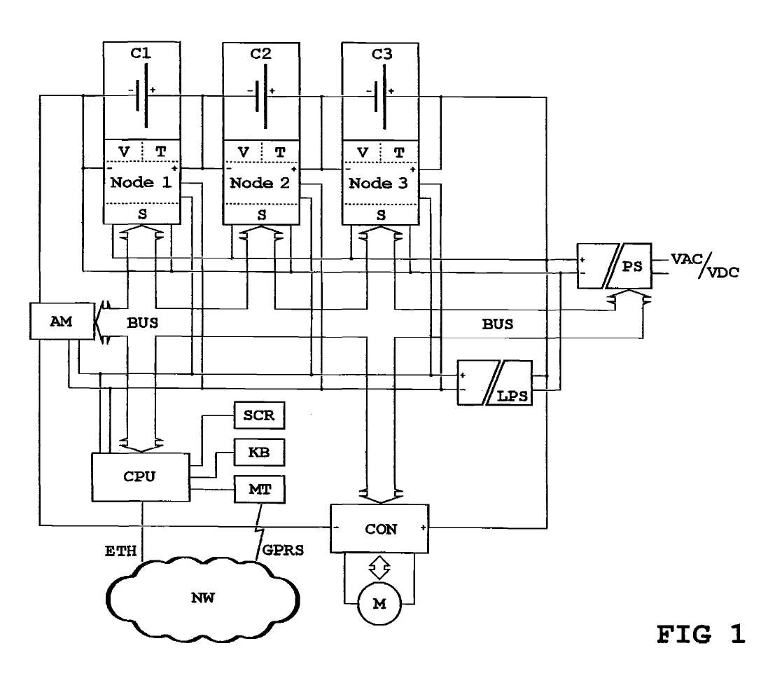

FIG. 1 shows a circuit diagram for blocks of the invention.

In reference to FIG. 1, there is shown a simplified block diagram for a system of the invention. The inventive management of a battery “C1, C2, C3” is monitored and controlled by a central processing unit “CPU”, in communication therewith being provided a data transfer network “NW”, as well as an intra-system communications network “BUS” for collecting information about cells. The same communication can be conveniently used for all data transmission between the system components. Associated with the CPU is a user interface, for example a keyboard “KB” or a graphic touch screen “SCR”.

The CPU functions preferably also as an entertainment centre, a navigation device provided with a map, an on-board computer, etc. The software of a test apparatus is capable of displaying detailed information about the history of each cell. For example, about trends of inter-cellular discrepancies or about voltages in the cells of an almost exhausted system in a loading situation. Hence, this has enabled verifying a system of the invention in practice.

A galvanically isolated main charger or power supply “PS” produces a direct current needed for charging the batteries under control of the central processing unit CPU. The cells C1, C2 and C3 are connected in series and through them all passes a current from the power supply PS and a load controller “CON”. A monitoring device “NODE 1”, “NODE 2”, “NODE 3” is in communication with each cell. Each cell monitoring device NODE (Cell control System Node, CSS-Node) is linked with the communications network BUS, by means of which the central processing unit CPU is able to collect cell-specific information and to control management of each cell. In communication with each monitoring device NODE is a thermometer ‘T’, a charger “S”, as well as a voltmeter “V” for each cell. Other instruments used for measuring cell properties can also be included in the system, for example mano- or hygro-meters. For the sake of simplicity, the drawing FIGURE does not include all accessories. The charger S acquires its current from the voltage of the entire battery or directly from the power supply PS. The charger S is galvanically isolated. In view of measuring and data processing electronics, the exemplary configuration is provided with a separate power source LPS. It takes its current from the power supply PS or from the entire battery pack. The power source LPS may also contain its own small backup batteries, enabling for example the central processing unit to operate during maintenance work, even if the main voltages were switched off.

When the power supply PS is not connected and the system is in a discharge cycle, the charger S set in communication with a NODE discharges the entire battery, if necessary, and charges an individual cell linked with the same monitoring device NODE 1-3. This enables providing a very high efficiency in battery equalization procedures during a discharge process. The difference between the chargers S and the energy derived from the cells is compensated for during a charging process by adjusting output of the power supply PS. The CPU executes compensatory calculations and controls the operation of all chargers. For the sake of clarity, the FIGURE only shows three cells C1-C3, in practice the number of cells is usually more than three.

The power input of a load “M”, i.e. the use of electric power charged in the cells, is controlled by the circuit CON which can be for example a DC-CD converter or a motor controller. The circuits PS and CON may also have elements common to both and the functions can be integrated in a single apparatus. It may also, for example, charge a battery during a braking process under the control of CPU. In electrically powered vehicles, it is beneficial to return some braking energy back to the system. Thus, if necessary, the CON may function in either direction. An apparatus and method of the invention are preferably employed in association with a battery-operated electrically powered vehicle. In vehicular application, it is particularly important to make the battery able to withstand as many charging and discharging cycles as possible and high charging and discharging powers. However, a method and apparatus of the invention are suitable for other applications as well, such as for the management of uninterruptible power supply or also stationary accumulator batteries, for example in the context of wind or solar power.

In a test apparatus of the invention, the NODE is for example a microprocessor-controlled, yet quite simple and economical device. The voltage source for all microprocessors and logical functions comprises a separate, secured power source. Thus, the operation of various elements of the system is not dependent on the actual charge status of a cell connected to a relevant NODE, nor does the power supply break up as a result of blowing the fuses of a NODE or in the event of a slump in the terminal voltage of a battery.

The NODE can be preferably provided with a programmable identification device for recording the operating history of a cell. Because of privacy protection and warranty data, the information is preferably encrypted or at least difficult to convert and read by outsiders.

During the course of a normal charging cycle, a regulable current and voltage for charging the system is generated by PS under the control of CPU. The charging process is typically started for example by using a variable constant current and by monitoring operating parameters of the cells. After the voltages have risen close to the values of a fully charged cell, transition is made to an equalizing charge, as necessary. At this point, the variable current at a constant voltage is supplied by the system's PS, depending on the number of active chargers S. The status condition is monitored by each cell tracking device NODE and this information is continuously collected by the central processing unit CPU. The charging is controlled by CPU in such a way that the current approaches zero after all chargers S have completed the tasks assigned thereto. If necessary, the system can be maintained in this status even for long periods of time.

The operation of NODE is actively controlled by CPU to make an optimal charge attainable. The notable functions include for example a slight overcharge, increasing temperature by switching off cell cooling, by switching on heating, by deep discharging individual cells, a discharge cycle proportionally higher or lower with respect to the true capacity of a cell in question.

Equalization can be performed with the power supply in operation or during a discharge cycle. In practice, the charging and discharging means in communication with NODE may consist of low-performance and economical standard components. High performance is not needed because the assigned procedures are of moderate dimensions. In addition, such procedures can also be executed at times other than during a charging process by using the joint charge of a battery for giving an extra charge to one of the cells. The same method can also be applied for discharging a single cell by activating the chargers S of all other cells except the one that requires discharging. If there are originally major discrepancies in a battery, replacing the cells immediately after first charging operations with cells of more consistent performance is more advisable than trying to equalize the original ones. In a system of the invention, the operator is in fact requested by CPU to book a service time for after-sales exchange of batteries as soon as possible or the time is possibly automatically booked by the system at the nearest point of service according to any given location. The operator can be contacted by way of a user interface to make sure that the times are convenient.

Being able to charge and discharge a single cell in a controlled manner, the system has a capability of decreasing or increasing the stress on this particular cell during a charge, storage or discharge cycle. A cell-specific temperature measurement is necessary because the properties of a cell fluctuate as a function of temperature. Moreover, the generation of heat provides information about the condition of a cell, more specifically about it's internal series resistance. Charging a cell which is already fully charged results in the generation of a considerable heat power, which quickly destroys the cell and causes a serious hazard. If the cell temperature raises too high, it is not possible to prevent fire by external means. This is another reason why the cell temperature must be monitored. It is also possible to provide a software-independent overheating protection, which overrides all other control and opens the battery circuit with the exception of cooling fans. Upon overheating, the battery may short-circuit, releasing an enormous amount of energy in a short period of time. In many advanced battery technologies, this is the same as fire.

Furthermore, the system of the invention is preferably provided with data transfer instruments “MT”, enabling the transmission of cell status monitoring data to other external media for analyses in purposes of product development. In addition, the same instruments can be used for updating software or a management algorithm. The instruments MT may constitute an integral part of the apparatus, for example a GPRS-modem, a 3G or a WLAN. The data transfer devices may also transmit information by way of wires, for example in connection with maintenance and charging processes, by using a wire-established communication link ETH.

A mobile phone can also be used, for example by means of a Bluetooth link, for data transfer and as a user interface. In practice, as early as in the near future, the maintenance cycle of electrically powered automobiles will probably be so long that information cannot be collected at a sufficient frequency by means of maintenance jobs alone. This is due to the fact that the number of wearing and serviceable parts in an electrically powered car is considerably less than in a vehicle powered by a combustion engine. For example, the wearing of brake pads is considerably lesser, the wearing parts of transmission are limited to wheel bearings, and even the wheel suspension can be of a design simpler than today and the body will be structurally simpler.

Since the latest battery technologies have a maintenance cycle of even up to 300.000 km or 20 years, there must be easier ways of monitoring the status of batteries and collecting information. In normal operation, the automobile may pay a visit to maintenance at the interval of five years. This is a cycle too long for the needs of product development, which is why it is preferred that service data about cells be collected also by means other than maintenance sessions. As pointed out above, the objective is to establish a data collection system covering all units sold, whereby the hardware manufacturer obtains important information and the customer can be served with anticipatory data and latest maintenance algorithms. The system's user interface can also be used in an agreed manner for marketing and publicity.

The system can also be used for measuring the capacity of each cell accurately and for draining each cell of each battery to a certain charge level by means of the chargers S. The controlling central processing unit CPU is capable of computing a joint current passing through the battery on the basis of information provided by the power supply PS, a NODE, and an ammeter “AM”. The ammeter is used for measuring a time integral of the current, i.e. a charge passing through the cells. Integration is effected either in the very ammeter AM or computed by the central processing unit CPU. On the other hand, each NODE responsible for a single cell is used for measuring or computing the current of a charger S to be set in parallel with a battery and the voltage across the poles of a battery, as well as other necessary parameters. The CPU is able to compute a joint capacity and efficiency for the cells by exploiting the measured parameters. In addition, the discrepancies of each cell with respect to other cells can be computed from the measuring results of each cell and from the data of charging instruments coupled in parallel with the cells. Discrepancies can be generally measured more accurately than a joint capacity. This facilitates a precise equalization of the cells. In practice, the properties of an entire system are assessments at best, but the relative discrepancies between the cells can be measured at a sufficient accuracy.

Since the system has its chargers S and PS implemented by switched mode technique and with a high efficiency, the overall efficiency is good despite the fact that for example the operation of a cell weaker than the others is alleviated by charging it during a discharge process and by charging the other cells respectively more during a charging cycle. The same reduction of stress for a single cell is also achieved if the charger S works in a reverse sense during a charging cycle, i.e. feeds current alongside the charger PS and has thereby some of the charging current running through a cell managed by the charger S guided past the cell and delivered back to serve as a charging current for all the cells. In here there is a difference to earlier U.S. Pat. No. 6,373,226 B1 (ITOU ET AL.) in a way that the system can support simultaneously several sells with different power. In aforementioned patent the supporting is made to one cell at time and only after the pre programmed parameters are reached. In this way it is not possible to achieve a proper cell management. Also the separate isolated switched mode power supply between the cell specific charger and the serial voltage of the battery provides considerable installation safety and reliability to the entity. That component may be for example integrated in association with the PS. Then it is possible to standardize the cell specific switched mode power supply to given voltage, and it is not dependent on the serial voltage of battery. The low galvanically isolated voltage, for example 24V of 75 V, creates installation safety.

Thus, a cell slightly weaker than others can be operated on a less deep charging and discharging cycle until the other cells have approached the weaker cell in terms of capacity. This enables equalizing the cells with a good overall efficiency and without wasting capacity of any cell unnecessarily. In practice, for example, the charging and discharging of a cell with a capacity 0.5% lower than others can be conducted with a cycle having a depth of 99% with respect to the other cells. As a result, the other cells are subjected to a slightly higher stress and inter-cellular discrepancies even out. Nevertheless, the capacity of an entire battery pack is utilized more thoroughly than in a traditional method, because it is only the cell weaker than others that has a slight piece of its capacity go intentionally unused.

Since the alleviation in the operation of a weaker cell is effected by using high-efficiency, inexpensive and low-capacity choppers, there will be no loss of valuable energy and no unnecessary generation of heat power. For example, in an accumulator battery of 1000 Ah, 1% equals 10 Ah, i.e., for example, a discharge and charge cycle of 5 h requires an average charging and discharging current of 2 A for providing a 1% lesser charge-discharge cycle. In practice, for example, a battery of 1000 Ah is large at least in vehicular use, and the charging time of 5 h requires a charging current of 200 A and, for example, with an operating voltage of 100V, the required power is 20 kW. Thus, according to the example, with a charging voltage of 4 V, the charger S of a single cell has a power demand of only 8 W. In addition, various methods can be combined, i.e., for example, one cell can be discharged with a 1 A current and others charged with a 1 A current or temperature differences can be used for creating unequal charging conditions among the cells, for example by turning down cooling. Modern cells are able to withstand quite powerful charging currents, and in the event of a very short charging time it is possible to have cells momentarily bypassed during a charging process, thus avoiding the need for powerful chargers S. On the other hand, the equalization of cells by regulating a charge can be generally executed at least several times a week by overnight charging or by using frequent rapid charging, but the cells can be stressed in many other ways to achieve a final result consistent with the invention.

The intentional overcharge of a cell stronger than others can be discharged during a discharging cycle to a greater depth than the others by having all other cells in a charging mode during the discharging cycle. In this case as well, the charge of a cell stronger than others will be exploited at a moderately high efficiency while other cells are in a charging process. Even in this case, the charger S of a cell stronger than others can be operated in a reverse sense during the discharging cycle. Hence, according to a preferred embodiment of the invention, not only can inter-cellular discrepancies equalized but also the capacity of cells can be exhausted more thoroughly than before without neglecting to use any of the cells' capacity or without wasting energy.

According to the invention, energy can also be wasted, for example by using just one voltage- or current-regulated joint charger and by dissipating outputs of the cells for resistances. In this case, cells can be bypassed in a charging process by using a low limited current for charging other cells or simply, instead of charging a single cell, by discharging the charge of all other cells for example by means of a resistance. In vehicular use, however, this is approach is less beneficial, because it generates a considerable amount of heat and is wasteful of capacity which is limited anyway. Wasting energy is more easy to accept in the context of a solar-cell powered charger, used for example in a summer house, because when the batteries are fully charged, the amount of energy exceeds the demand anyway and the involved charging powers are not particularly high.

It is notable that the cells of a high-quality system are very close to each other in terms of properties. The manufacturer will be able to measure the cells' properties and select cells as identical as possible for an intended system. Thus, in practice, the discrepancies between cells should be in the order of less than a percent. This seems like a small difference, but since operating in compliance with the weakest cell, as in the available state of the art, deteriorates the weakest cell even further, the final outcome will be a considerable reduction in the service life of a battery pack in comparison with what is accomplished by a system of the invention. In practice, a sufficient power for the charger S in communication with a NODE is the power of a few watts, even if the cell had a capacity in excess of 1000 Ah. This also differs from state of art, as by anticipating and planning the cell management in advance it is possible to avoid momentarily needed high powers.

Components V, T, S and NODE can be preferably included in one and the same circuit board, which is attached to each cell.

Currently available individual cells are able to withstanding a few thousand charge-discharge cycles used as solitary cell (cf. newest cellular phones), even with best systems of the prior art. It is generally reported that for example 60% of the rated capacity shall remain for at least 2000 charging cycles. When connected in series, the cyclic service life of prior art systems may fall to even less than 200. According to prototype tests, a system of the invention is capable of prolonging the system age to at least match the service life of an individual cell. In addition, the system's load capacity and usability shall improve.

An electrically powered vehicle fitted with a system of the invention can be guaranteed for an economically viable service life. Because the replacement costs of batteries represent a specific operating expense which is most significant for an electrically powered vehicle, the system of the invention can make a major difference in the overall economy of the electrically powered vehicle. A potential result of this could be a breakthrough in electromobile technologies anticipated for more than 140 years. In addition, the properties of a battery equalized according to the invention are known precisely. The CON may allow for the drastic loading of even quite an empty battery without fear of destroying the cells.

As for the user of an electrically powered vehicle, a practical meaning of this is increased useful operating range and the vehicle manufacturer may allow for the use of higher capacities also for half-empty cells. It must be kept in mind that, even if the supervision logic of cells had time to restrict capacities in fierce acceleration, the sudden restriction of capacities may cause an accident. The system of the invention is more precisely aware of the remaining safely usable capacity, thus reducing the risk of surprise during a drive. Also, the capacity to be left in reserve can be used for taking the power peak all the way to exhaustion.

A result of this is also a possibility of moving the vehicle to a safer place after the capacity has been exhausted, in the event that this should happen. As a rule, the system leaves some safety gap at both top and bottom ends in cycles for enhancing the service life of a battery. This spare capacity can be used in an emergency.

As for technology, it can be stated that the system of the invention is able to allow a higher level of integration with the vehicle manufacturer. In other words, the accumulator battery can be built in the structures of a vehicle in such a way that its maintainability is not a limiting factor in terms of positioning the same. The accumulator battery can be built as part of the load-bearing structures of a vehicle. This method may provide a remarkable drop in vehicle manufacturing costs. Additionally, while the cells are developing the new cell types can be utilized with full benefit faster, because the data can be collected fast and easy manner from a large group of cells and also the management programmes can be updated afterwards to the vehicles to correspond the properties of new cells. The system according the invention is very flexible and makes possible to use different cell types inside a car model family without altering the cell management electronics itself.

It seems that the battery management according to the invention would represent one significant step forward in the process of developing a comprehensively economical and comfortable electrically powered vehicle suitable for daily use. The central processing unit CPU can be replaced with cell-specific devices, which are more intelligent than what is presently described and which are capable of interactive dialogue without a central processing unit. There may also be two or more systems in parallel or in series or in the form of totally separate devices in the mode of delivering energy, for example in ocean-going vessels, separately for moving about and lighting. This case involves an equalization of more complicated overall systems. The systems may also have elements thereof geographically separated, provided that the data transfer network NW functions as expected. Consequently, for example, even thousands of various systems around the world can be operated and monitored by way of a single user interface.

In addition, the system can be provided with various types of battery cells or use can be made of supercapacitors or other power sources for generating a high instantaneous current or passing a charge from system to system. These multiple variations belong within the patent's scope of protection, although the present description of an inventive application only explains the function of a simple test apparatus.

1. A method for the management of rechargeable series-connected cells (C1, C2, C3) by means of individual measurements and applied statistics, wherein each cell is monitored during the course of its charging, storage or discharging cycle for measuring the cell properties, and the cells better than others are treated in a way that they are stressed more than others during the chare-discharge cycle, or the deterioration of cells weaker than others is slowed down by stressing them less than other cells in a way that the properties of cells are permanently closing to each other.

2. A method as set forth in claim 1, wherein for each cell is determined an optimal operational area in the used capacity window, in a way that for each cell is determined the charge and discharge levels or temperature areas, following of which results to cell properties approaching each other and finally the individual cells behaviour approaches each other, and the battery behaviour as whole in the whole area of charge window improves so that the battery can be charged and discharged in the ends of the charge window with higher currents without safety or damage risk.

3. A method for equalizing battery cell capacities as part of the method as set forth in claim 1, wherein in accordance the measured values the cell charge levels are maintained in an optimal state for entire system in a way that the cells are not always charged as full, but some of the cells are left lower charge than others to slow down the cell active material deterioration and therefore the for equalizing the relatively weaker cell's capacity to the level of other cells.

4. A method as set forth in claim 1, wherein properties of a single cell or group of cells are deteriorated permanently by charging more than others, discharging deeper than others, causing heating more than others, or stressing single cells other ways different than others to cause the discrepancies between the cells to mitigate.

5. A method as set forth in claim 3, wherein properties of a single cell or group of cells are adjusted by easing the operating conditions of cells weaker than others by for example charging them during the discharge cycle and respectively charging them in a way needed by the cell during the charge cycle.

6. A method as set forth in claim 1, wherein for each cell is assigned an optimal operating area in usable capacity window in respect to other cells.

7. A method as set forth in claim 1, wherein the method further comprises a step, in which cell measurement information is collected from several battery of cells to develop and test the management algorithm.

8. A method as set forth in claim 7, wherein the method further comprises a step, in which the management algorithm is updated to group of cell management devices remotely.

9. An apparatus for the management of cells, said apparatus comprising means for measuring serially connected battery cells, wherein the apparatus comprises means for measuring inter-cellular inconsistencies in a battery and means for individually manipulating the cells at least during the charge and discharge cycle in order to permanently mitigate inter-cellular discrepancies in properties during the future charge discharge cycles.

10. An apparatus as set forth in claim 9, wherein the charge adjusting means connected in parallel with single cells are dimensioned for a small current that is maximum 2% of the current caused by main charger or load.

11. Software for use in battery management, wherein the software keeps track on the properties of cells and causes intentionally partial deterioration of cells better than others, or stresses less the cells weaker than others.

12. A system for battery management wherein the highest control level of the logic is situated outside of the management apparatus in a external server in the remote end of telecommunications connection, in which case the external server can authenticate the battery management apparatus or it's data for management, registering, or the management algorithms against forgery or copying.
